(19) United States
(12) Patent Application Publication
(10) Pub. No.: US 2016/0025276 A1
(43) Pub. Date: Jan. 28, 2016

(54) LIGHT EMITTING DIODE SPOTLIGHT

(71) Applicant: HENGDIAN GROUP TOSPO LIGHTING CO., LTD., DONGYANG ZHEJIANG (CN)

(72) Inventors: Wenhua FU, DONGYANG ZHEJIANG (CN); Chao FU, DONGYANG ZHEJIANG (CN)

(21) Appl. No.: 14/702,098

(22) Filed: May 1, 2015

(30) Foreign Application Priority Data
Jul. 22, 2014 (CN) 201410350058.9

(51) Int. Cl. F21K 99/00; F21V 17/12; F21V 17/16; F21V 29/10; F21V 3/02

(52) U.S. Cl. CPC F21K 9/1375; F21V 29/10; F21V 3/02; F21V 17/164; F21V 17/12; F21Y 2101/02

(57) ABSTRACT

The present disclosure relates to a light emitting diode(LED) spotlight comprising a housing, a driver, a cover, a base, an LED substrate, and a lampshade. The housing has an accommodation portion and an opening, the driver is disposed in the accommodation portion, the cover covers the opening. The housing has a plurality of support arms disposed thereon, and the base supports the plurality of support arms. The base has a heat dissipating surface, on which the LED substrate is disposed. The lampshade covers the base and is located on a light-emitting surface of the LED substrate. The distance between the base and the cover is 20-50% of the height of the LED spotlight.

### CROSS-REFERENCE TO RELATED APPLICATION

This application is related to and claims priority to Chinese Patent Application Serial No. 201410350058.9, filed Jul. 22, 2014, entitled LIGHT EMITTING DIODE SPOTLIGHT, the entirety of which is incorporated herein by reference.

### TECHNICAL FIELD

The present disclosure relates to lamps, and more particularly, to a light emitting diode (LED) spotlight.

### BACKGROUND

LEDs having advantages such as long lifetime, small volume, high shock-resistance, low heat generation, and low power consumption, etc., and thus are widely applied in various indicators and light sources at home and in various appliances. In recent years, LEDs gradually take place of fluorescent lamps and incandescent lamps in some fields due to the increasingly higher luminescent efficiency of LEDs.

Currently, except for the light source portion, LED lamps seek to use conventional lamp structures to gradually update light sources. For example, current LED spotlights retain a conventional structure which assembles the light source in a housing. However, due to the high amount of heat emitted by LED lamps, the requirements on their heat dissipation are higher than those for conventional light sources which have lower requirements on heat dissipation.

### SUMMARY

The present disclosure provides an LED spotlight having better heat dissipation rate.

An aspect of the present disclosure provides an LED spotlight comprising a housing, a driver, a cover, a base, an LED substrate, and a lampshade. The housing has an accommodation portion and an opening. The driver is disposed in the accommodation portion, and the cover covers the opening. The housing has a plurality of support arms disposed thereon, and the base is supported by the plurality of support arms. The base has a heat dissipating surface, on which the LED substrate is disposed. The lampshade covers the base and is located on a light-emitting surface of the LED substrate. The distance between the base and the cover is 20-50% of the height of the light emitting diode spotlight.

In an embodiment of the present disclosure, at least one of the support arms has a groove disposed thereon, the groove connects the base and the housing, one or more wires of the LED substrate enter into the housing through the groove, and the LED spotlight further comprises at least one wire covers detachably snapped into the groove respectively.

In an embodiment of the present disclosure, each of the support arms has a groove disposed thereon, the grooves connect the base and the housing, one or more wire of the LED substrate enter into the housing through the groove, and the LED spotlight further comprises a plurality of wire covers each detachably snapped into each of the grooves.

In an embodiment of the present disclosure, a plurality of via holes are disposed in the base, a via hole is disposed in each of the wire covers, and a screw hole is disposed in each of support arms, where a plurality of first screws sequentially go through the via holes in the base and the via holes in the wire covers and then lock into the screw holes in the support arms.

In an embodiment of the present disclosure, a plurality of via holes are disposed in the base, and a screw hole is disposed in each of the support arms, where a plurality of second screws go through the via holes in the base and then lock into the screw holes in the support arms.

In an embodiment of the present disclosure, the LED spotlight further comprises a lamphead connected to the housing.

In an embodiment of the present disclosure, a plurality of breaches are disposed in the LED substrate, a plurality of via holes are disposed in the base, and at least one screw hole is disposed in each of the wire covers, where a plurality of screws sequentially go through the breaches in the LED substrate and the via holes in the base, and then lock into the screw holes in the wire covers.

In an embodiment of the present disclosure, the wire cover has a plurality of short arms, each of which has a screw hole disposed therein.

In an embodiment of the present disclosure, a plurality of breaches are disposed in the LED substrate, and at least one screw hole is disposed in the base, where a plurality of screws go through the breaches in the LED substrate and then lock into the screw holes in the base.

In an embodiment of the present disclosure, the LED substrate is adhesively connected to the base.

In an embodiment of the present disclosure, the LED substrate is snapped into the base via buckles.

In an embodiment of the present disclosure, the distance between the base and the cover is 10-50 mm.

In an embodiment of the present disclosure, the number of the support arms is 2-5.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows an exploded view of a LED spotlight according to a first embodiment of the present disclosure.

FIG. 2 shows a diagram of a housing of an LED spotlight according to a first embodiment of the present disclosure.

FIG. 3 shows a diagram of a wire cover of an LED spotlight according to a first embodiment of the present disclosure.

FIGS. 4-5 show an assembling procedure of some components of a LED spotlight according to a first embodiment of the present disclosure.

FIG. 6 shows a diagram of a base of an LED spotlight according to a first embodiment of the present disclosure.

FIG. 7 shows an assembled view of an LED spotlight according to a first embodiment of the present disclosure.

FIG. 8 shows an exploded view of an LED spotlight according to a second embodiment of the present disclosure.

FIG. 9 shows an assembled view of an LED spotlight according to a second embodiment of the present disclosure.

### DETAILED DESCRIPTION

### First Embodiment

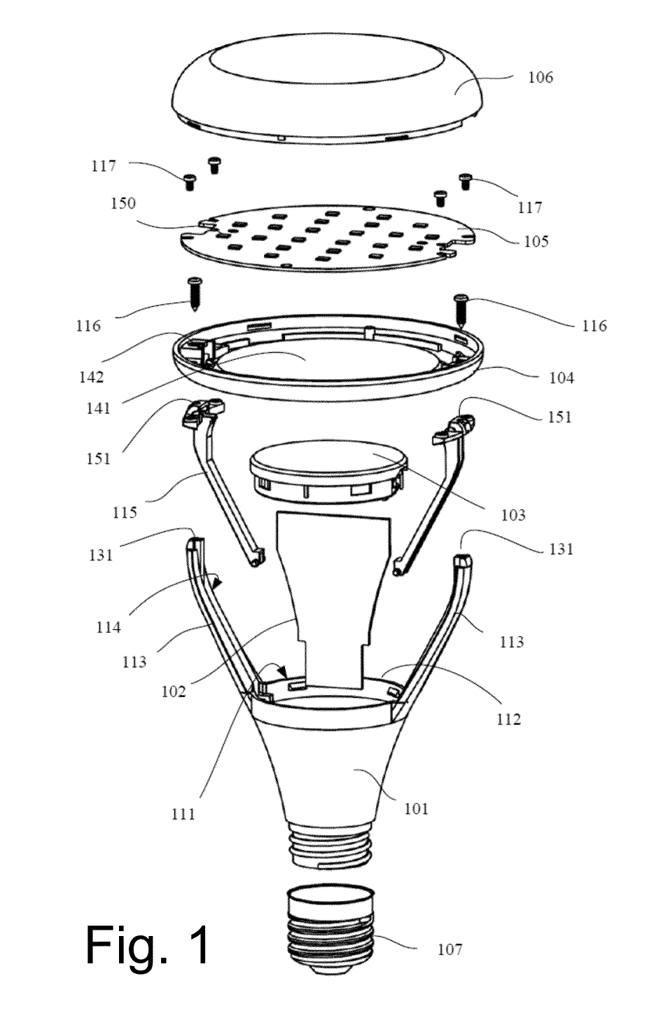

FIG. 1 shows an exploded view of a light emitting diode spotlight according to a first embodiment of the present disclosure. As shown in FIG. 1, the light emitting diode spotlight 100 according to the present embodiment comprises a housing 101, a driver 102, a cover 103, a base 104, a light emitting diode (LED) substrate 105, and a lampshade 106. The housing 101 has an accommodation portion 111 and an opening 112. The driver 102 is for example a printed circuit board (PCB). The driver 102 is disposed in the accommodation portion 111. The cover 103 covers the opening 112 to seal the driver 102. In an embodiment, the cover 103 may be snapped into the housing 101 via buckles, and is optionally further secured with auxiliary gluing.

The housing 101 has a plurality of support arms 113 disposed thereon and extending upwards from the housing 101. For example, the support arms 113 may extend upwards from the edge of an opening of the housing 101. In the embodiment of the present disclosure, the number of support arms 113 may be 2-5, and in the present embodiment is 2. The support arms 113 are preferably uniformly disposed on the housing 101.

The base 104 is supported by each of the support arms 113. The base 104 has a heat dissipating surface 141, on which the LED substrate 105 is disposed. The base 104 is used to support the LED substrate 105, and is also used for heat dissipation of the light emitting diode substrate 105. The portion under the heat dissipation surface 104 of the base 104 is used for heat dissipation. The material of the base 104 may be metal or plastic, and is plastic in the present embodiment. The lower surface of the base 104 may undergo a baking finish processing. The LED substrate 105 has one or more LED chips 150 disposed on its upper surface. The material of the LED substrate 105 may be aluminum alloy, glass fiber board, or ceramic board. For example, the diameter of an outer profile of the LED substrate 105 may be 40-100 mm, for example 88 mm.

The lampshade 106 covers the base 104 and is located on a light-emitting surface (i.e., the upper surface in this embodiment) of the LED substrate 105. The lampshade 106 may be snapped into the base 104 via buckles, and is preferably further secured with auxiliary gluing.

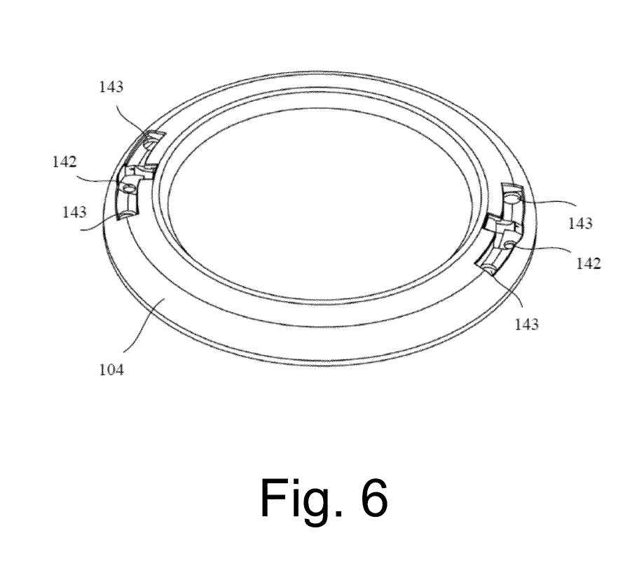

The distance S between the bottom of the base 104 and the upper surface of the cover 103 is 20-50% of the height H of the whole spotlight (See FIG. 6). Due to the height change of the whole spotlight, this distance S may be 10-50 mm. For example, this distance S may be 37 mm. Due to this distance, the surroundings of the whole base 104 are not shielded. Thus, the base 104 has a large contact surface to air, resulting a short heat conducting path, and the convection speed of outside air is very quick. Therefore, the heat dissipation performance is greatly increased.

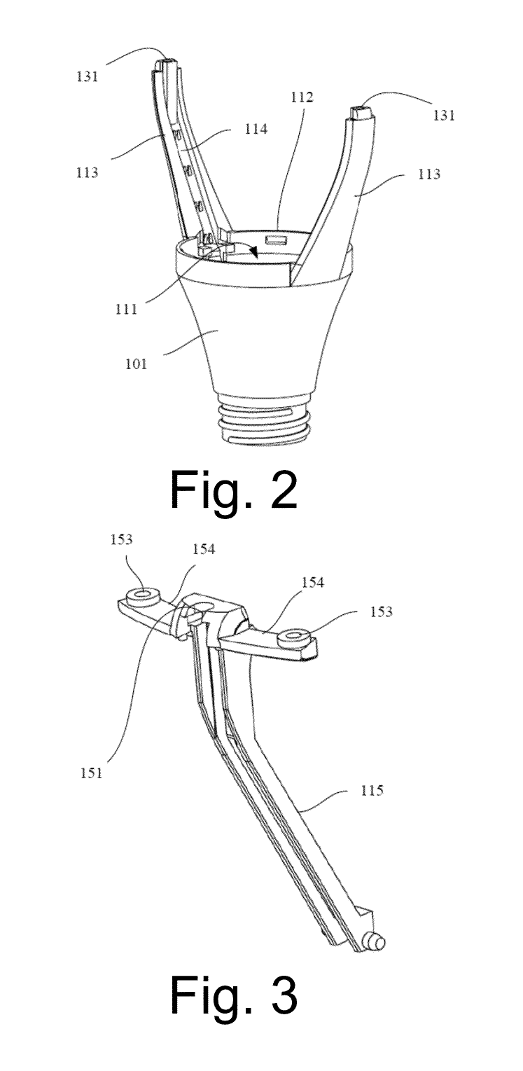

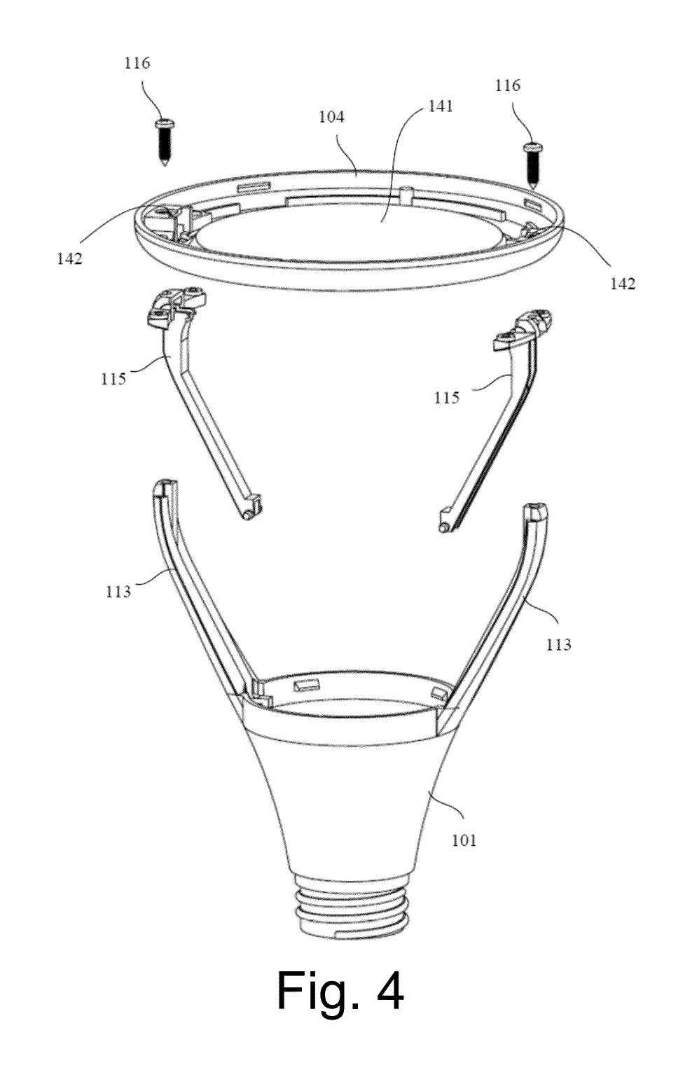

FIG. 2 shows a diagram of a housing of a light emitting diode spotlight according to a first embodiment of the present disclosure. FIG. 3 shows a diagram of a wire cover of a light emitting diode spotlight according to a first embodiment of the present disclosure. With reference to FIGS. 2 and FIG. 3, each of the support arms 113 has a groove 114 disposed thereon. Each groove 114 connects the base 104 and the housing 101. Wires (e.g., positive and negative wires) of the LED substrate 105 may enter into the housing 101 through the grooves 114. Additionally, each groove 114 is equipped with a wire cover 115. The wire cover 115 is detachably snapped into the groove 114 to protect one or more of the wires in the groove 114.

Although each support arm 113 has disposed thereon a groove 114 as shown in FIG. 2, it should be understood that grooves 114 may be disposed on some (for example one or more) of the support arms 113 as desired while the remaining support arms 113 may have no groove disposed.

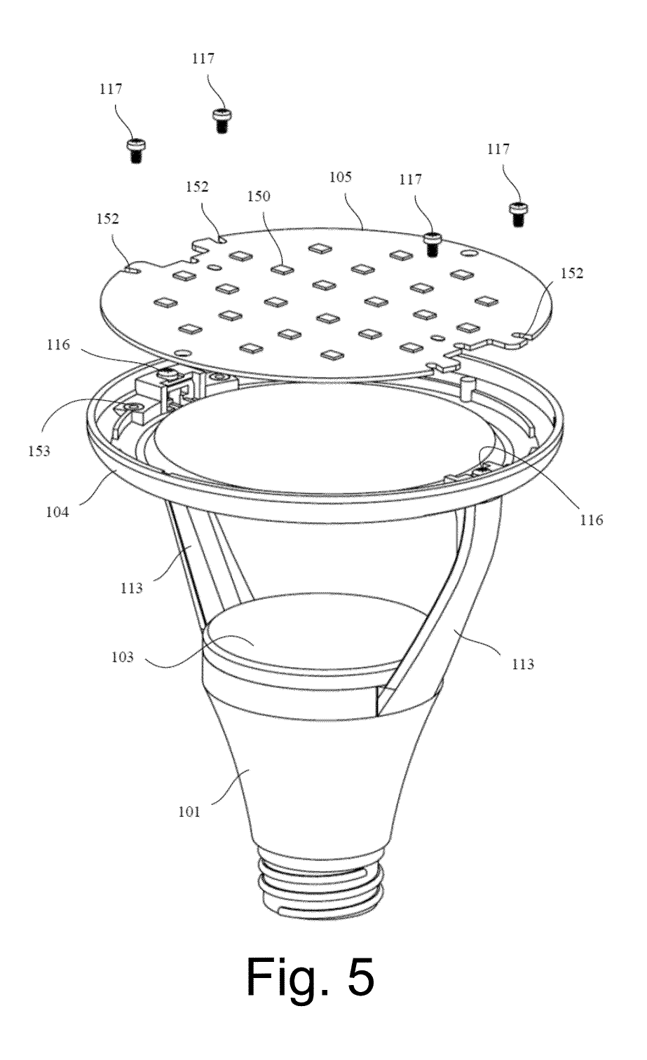

For assembling, as shown in FIG. 3, FIG. 4 and FIG. 6, a plurality of via holes 142 may be disposed in the base 104, and a via hole may be disposed in each of the wire covers 115, and a screw hole 131 is disposed in each of the support arms 113. A plurality of first screws 116 secure the base 104 by going through the via holes 142 in the base 104 and the via holes 151 in the wire covers 116 and then locking into the screw holes 131 in the support arms.

For those support arms 113 with no groove 114 and no wire cover 115 disposed, a screw hole 131 is disposed in each of these support arms 113 while a plurality of via holes 142 are disposed in the base 104. A plurality of first screws 116 first go through the via holes 142 in the base 104, and then lock into the screw holes 131 in those support arms 113.

On the other hand, with reference to FIG. 5, breaches 152 are disposed in the LED substrate 105, a plurality of via holes 143 are disposed in the base 104, and one or more screw holes 153 are disposed in the wire covers 115. To reinforce the whole structure, the number of screw holes 153 on each wire cover 115 is two. With reference to FIG. 3, the two screw holes 153 in the groove 115 are disposed in two short arms 154 located at both sides of the groove 115, respectively. In an embodiment, the short arms 154 are arc-shaped, and have a length of 5-30 mm, for example 10 mm. When the wire cover 115 is combined with the base 104, the screw holes 153 in the wire cover 115 are in alignment with via holes 143 in the base 104. A plurality of second screws 117 sequentially go through the breaches 152 in the LED substrate 105, the via holes 143 in the base 104, and then lock into the screw holes 153 in the wire cover 115s.

In another embodiment, a plurality of breaches 152 are disposed in the LED substrate 105, and a plurality of screw holes are disposed in the base 104. A plurality of second screws 117 go through the breaches 152 in the LED substrate 105, and then lock into the screw holes in the base 104.

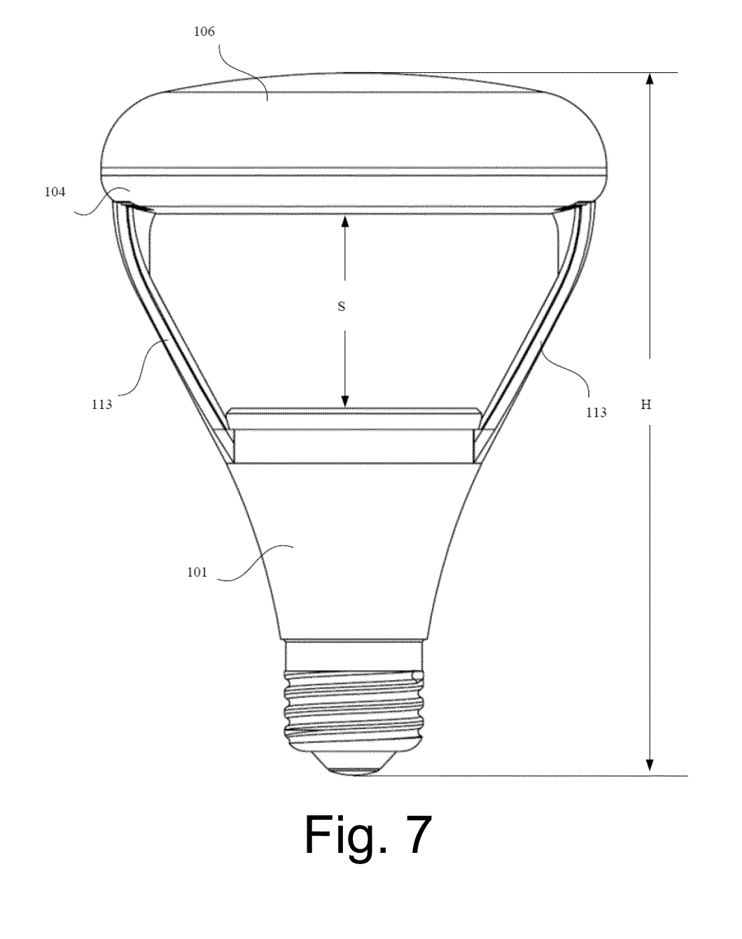

FIG. 7 shows an assembled view of a light emitting diode spotlight according to a first embodiment of the present disclosure. As shown in FIG. 7, after the previous assembling, the bottom of the housing 101 connects to a lamphead 107 to constitute a complete light emitting diode spotlight.

The structure of the light emitting diode of the present embodiment is simple, is convenient to assemble, and meanwhile reinforces the whole structure, and implement the fixed connections among the light emitting diode substrate, the heat dissipation base, the wire covers, and the support arms.

### Second Embodiment

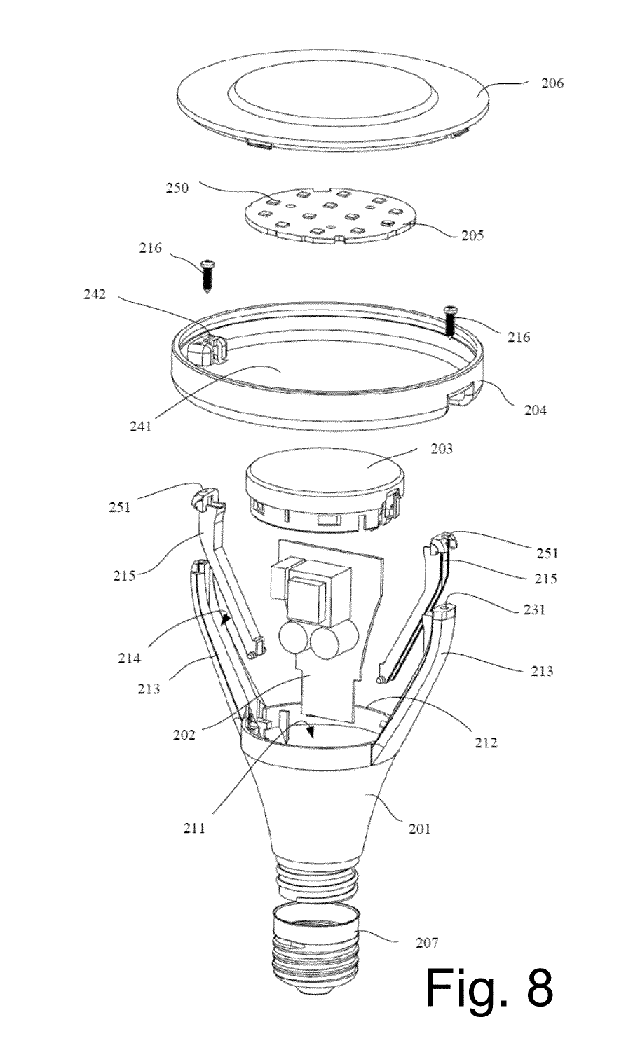

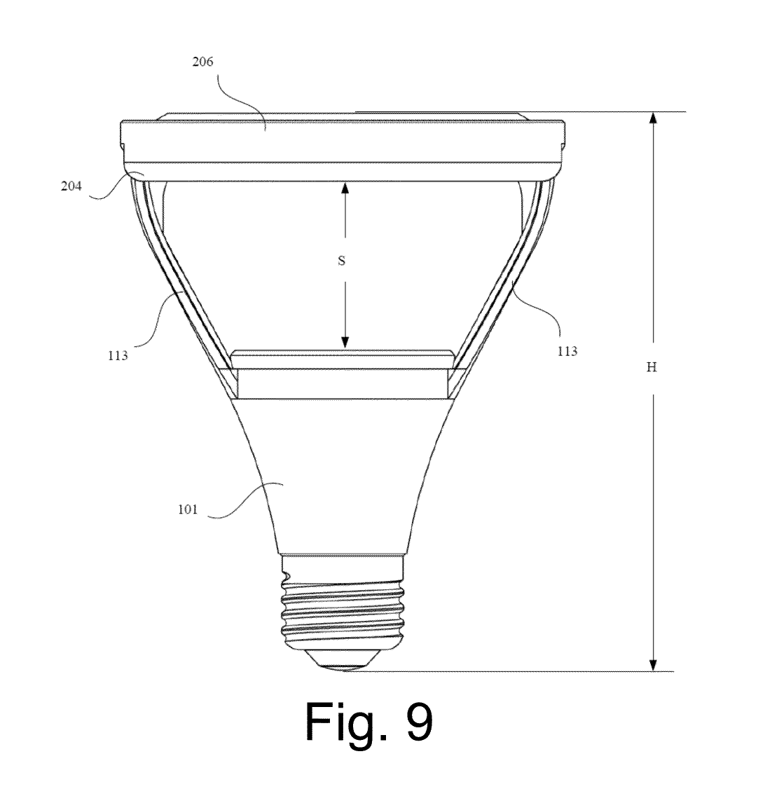

FIG. 8 shows an exploded view of a light emitting diode spotlight according to a second embodiment of the present disclosure. FIG. 9 shows an assembled view of a light emitting diode spotlight according to a second embodiment of the present disclosure. As shown in FIG. 8 and FIG. 9, the light emitting diode spotlight 200 according to the present embodiment comprises a housing 201, a driver 202, a cover 203, a base 204, a nLED substrate 205, and a lampshade 206. The housing 201 has an accommodation portion 211 and an opening 212. The driver 202 is for example a printed circuit board (PCB). The driver 202 is disposed in the accommodation portion 211. The cover 203 covers the opening 212 to seal the driver 202. In an embodiment, the cover 203 may be snapped into the housing 201 via buckles, and is optionally further secured with auxiliary gluing.

The housing 201 has a plurality of support arms 213 disposed thereon and extending upwards from the housing 201. For example, the support arms 213 may extend upwards from the edge of an opening of the housing 201. In the embodiment of the present disclosure, the number of support arms 213 may be 2-5, and in the present embodiment is 2. The support arms 113 are preferably uniformly disposed on the housing 201.

The base 204 is supported by each of the support arms 113. The base 204 has a heat dissipating surface 241, on which the LED substrate 205 is disposed. The base 204 is used to support the LED substrate 205, and is also used for heat dissipation of the LED substrate 205. The portion under the heat dissipation surface 204 of the base 204 is used for heat dissipation. The material of the base 204 may be metal or plastic. In the present embodiment, the material of the base 204 is metal such as aluminum or aluminum alloy, etc. The lower surface of the base 204 may undergo a baking finish processing. The LED substrate 205 has one or more LED chips disposed on its upper surface. The material of the LED substrate 205 may be aluminum alloy, glass fiber board, or ceramic board. For example, the diameter of an outer profile of the LED substrate 205 may be 40-100 mm, for example 88 mm.

The lampshade 206 covers the base 204 and is located on a light-emitting surface (i.e., the upper surface in this embodiment) of the LED substrate 205. In an embodiment, the lampshade 206 may be snapped into the base 204 via buckles, and is preferably further secured with auxiliary gluing. In another embodiment, the lampshade 206 may be secured to the base 204 via ultrasonic welding.

The distance S between the bottom of the base 204 and the upper surface of the cover 203 is 20-50% of the height H of the whole spotlight. Due to the height change of the whole spotlight, this distance S may be 10-50 mm. For example, this distance S may be 37 mm. Due to this distance, the surroundings of the whole base 204 are not shielded. Thus, the base 204 has a large contact surface to air, resulting a short heat conducting path, and the convection speed of outside air is very quick. Therefore, the heat dissipation performance is greatly increased.

Each support arm 213 has a groove 214 disposed thereon. Each groove 114 connects the base 204 and the housing 201. Wires (e.g., positive and negative wires) of the LED substrate 205 may enter into the housing 201 through the grooves 214. Additionally, each groove 214 is equipped with a wire cover 215. The wire cover 215 is detachably snapped into the groove 214 to protect one or more the wire in the groove 214.

Although each support arm 213 has disposed thereon grooves 214 as shown in FIG. 7, it should be understood that grooves 214 may be disposed on some (for example one or more) of the support arms 213 as desired while the remaining support arms 213 may have no groove disposed.

For assembling, a plurality of via holes 242 may be disposed in the base 204, and a via hole 251 may be disposed in the wire cover 215, and a screw hole 231 is disposed in each of support arm 213. A plurality of first screws 216 secure the base 204 by going through the via holes 242 in the base 204 and the via holes 251 in the wire covers 215 and then locking into the screw holes 231 in the support arms 213.

For those support arms 213 with no grooves 214 and nowire covers 215 disposed, a screw hole 231 is disposed in each of the support arms 213 while a plurality of via holes 242 are disposed in the base 204. A plurality of first screws 216 first go through the via holes 242 in the base 204, and then lock into the screw holes 231 in those support arms 213.

The structure of the LED of the present embodiment is simple, is convenient to assemble, and meanwhile reinforces the whole structure, and implement the fixed connections among the LED substrate, the heat dissipation base, the wire covers, and the support arms.

In addition, the LED substrate 205 may be secured via adhesive heat conductive silicone or via buckles.

The LED spotlight according to the above embodiments of the present disclosure supports the base and the light emitting diode substrate away from the housing with support arms so that the bottom of the base is at a distance from the upper surface of the cover. Thus, the surroundings of the whole base 104 are not shielded. Thus, the base 104 has a large contact surface to air, resulting a short heat conducting path, and the convection speed of outside air is very quick. Therefore, the heat dissipation performance is greatly increased. The structure of the light emitting diode according to the above embodiments of the present embodiment is simple, is convenient to assemble, and meanwhile reinforces the whole structure, and implement the fixed connections among the light emitting diode substrate, the heat dissipation base, the wire covers, and the support arms.

While the present disclosure has been described with reference to these specific embodiments, those ordinarily skilled in the art may readily recognize that the above embodiments are merely provided to describe the present disclosure, and may have various equivalent changes or replacements without departing from the spirit of the present disclosure. Therefore, the changes and variations to these embodiments that are within the scope of the spirit of the disclosure also fall within the scope of the claims of the present application.

1. A light emitting diode (LED) spotlight comprising a housing, a driver, a cover, a base, an LED substrate, and a lampshade;
the housing has an accommodation portion and an opening, the driver is disposed in the accommodation portion, the cover covers the opening;
the housing has a plurality of support arms disposed thereon, and the base is supported by the plurality of support arms;
the base has a heat dissipating surface, on which the LED substrate is disposed;
the lampshade covers the base and is located on a light-emitting surface of the LED substrate; and
the distance between the base and the cover is 20-50% of the height of the LED spotlight.

2. The LED spotlight of claim 1, wherein at least one of the support arms has a groove disposed thereon, the groove connects the base and the housing, at least one wire of the LED substrate enters into the housing through the groove; and
the LED spotlight further comprises at least one wire cover detachably snapped into the groove respectively.

3. The LED spotlight of claim 1, wherein each of the support arms has a groove disposed thereon, the grooves connect the base and the housing, at least one wire of the LED substrate enters into the housing through the grooves; and
the LED spotlight further comprises a plurality of wire covers each detachably snapped into each of the grooves.

4. The LED spotlight of claim 3, wherein a plurality of via holes are respectively disposed in the base, a via hole is disposed in each of the wire covers, and a screw hole is disposed in each of the support arms, where a plurality of first screws sequentially go through the via holes in the base and the via holes in the wire covers and then lock into the screw holes in the support arms.

5. The LED spotlight of claim 1, wherein a plurality of via holes are disposed in the base, and a screw holes is disposed in each of support arms, where a plurality of second screws go through the via holes in the base and then lock into the screw holes in the support arms.

6. The LED spotlight of claim 1, further comprising a lamphead connected to the housing.

7. The LED spotlight of claim 3, wherein a plurality of breaches are disposed in the LED substrate, a plurality of via holes are disposed in the base, and at least one screw hole is disposed in the each of wire covers, where a plurality of second screws sequentially go through the breaches in the LED substrate and the via holes in the base, and then lock into the screw holes in the wire covers.

8. The LED spotlight of claim 7, wherein the wire cover has a plurality of short arms, each of the plurality of short arms having a screw hole disposed therein.

9. The LED spotlight of claim 1, wherein a plurality of breaches are disposed in the light emitting diode substrate, and at least one screw hole is disposed in the base, where a plurality of second screws go through the breaches in the LED substrate and then lock into the screw holes in the base.

10. The LED spotlight of claim 1, wherein the distance between the base and the cover is 10-50 mm.
